(19) United States
(12) Patent Application Publication
(10) Pub. No.: US 2010/0208209 A1
(43) Pub. Date: Aug. 19, 2010

(54) OPTICAL APPARATUS AND PROJECTION TYPE IMAGE DISPLAY APPARATUS

(75) Inventor: Yasuyuki HIROUCHI, Osaka (JP)

Correspondence Address: NOVAK DRUCE + QUIGG LLP, 300 NEW JERSEY AVENUE, NW, FIFTH FLOOR, WASHINGTON, DC, 20001, US

(73) Assignee: SANYO Electric Co., Ltd., Osaka (JP)

(21) Appl. No.: 12/630,547

(22) Filed: Dec. 3, 2009

(30) Foreign Application Priority Data
Dec. 5, 2008 (JP) 2008-311633

(51) Int. Cl. G03B 21/14; G03B 21/20

(52) U.S. Cl. 353/20; 353/119; 353/85

(57) ABSTRACT

An optical apparatus includes a frame, having optical components, mounted on a casing by means of an auxiliary member. The casing is provided with a groove in which the frame is inserted and a mount section to which a first part of the auxiliary member is fixed. The frame is provided with a frame-side positioning section engaged with a second part of the auxiliary member when the frame is inserted in the groove and then set at a predetermined angle of rotation. The auxiliary member is provided with the first part fixed to the mount section of the casing and the second part engaged with a frame-side positioning section. The first and the second part of the auxiliary member are formed in positions separate from each other while the second part is engaged with the frame-side positioning section under the elastic force of the auxiliary member.

### CROSS-REFERENCE TO RELATED APPLICATIONS

This application is based upon and claims the benefit of priority from the prior Japanese Patent Applications No. 2008-311633, filed on Dec. 5, 2008, the entire contents of which are incorporated herein by reference.

### BACKGROUND OF THE INVENTION

1. Field of the Invention

Thp present invention relates to an optical apparatus having polarization plates and a projection type image display apparatus using the optical apparatus.

2. Description of the Related Art

The optical system (optical apparatus) of a projection type image display apparatus such as a liquid crystal projector often requires adjustment of the angle of polarization plates with respect to the optical axis. A known technology to realize such adjustment rests on rotating the polarization plates. In the known technology, a frame fitted with a polarization plate is adjusted by rotation and then fixed to a casing by screw tightening under direct pressure from an auxiliary member.

An arrangement as mentioned above, however, is subject to rotating or pressing loads when the screws are tightened. As a result, the polarization plate can move during or after the process of adjustment, and so the angle of the polarization plates with respect to the optical axis cannot be adjusted accurately.

### SUMMARY OF THE INVENTION

The present invention has been made to solve problems as mentioned above, and a purpose thereof is to provide an optical apparatus and a projection type image display apparatus incorporating the optical apparatus, which enable the fixing of a frame fitted with a polarization plate to a casing without applying any undesirable load thereon so that the adjusted state can be maintained.

One embodiment of the present invention relates to an optical apparatus. An optical apparatus includes a frame, having optical components, mounted on a casing, wherein the casing is provided with a groove in which the frame is inserted and a mount section to which a first part of an auxiliary member used to fix the casing and the frame is fixed, wherein the frame is provided with a frame-side positioning section which is engaged with a second part of the auxiliary member when the frame is inserted in the groove and set at a predetermined angle of rotation, wherein the auxiliary member is provided with the first part which is fixed to the mount section of the casing and the second part which is engaged with a frame-side positioning section, and wherein the first part and the second part of the auxiliary member are formed in positions separate from each other while the second part is engaged with the frame-side positioning section under an elastic force of the auxiliary member.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a perspective view showing a liquid crystal projector, which is a projection type image display apparatus, according to an embodiment of the present invention;

FIG. 2 is a perspective view of a liquid crystal projector with a top casing thereof removed;

FIG. 3 illustrates an exemplary structure of an optical system;

FIG. 4 is a perspective view showing major parts with a lid open;

FIGS. 5A and 5B illustrate a major structure and an operation of a light source unit according to an embodiment of the present embodiment;

FIG. 6 is an exploded perspective view of a prism assembly, according to an embodiment of the present invention, as viewed obliquely from top showing how the prism assembly is mounted;

FIG. 7 is an exploded perspective view thereof as viewed obliquely from below;

FIG. 8 is a vertical cross-sectional view showing substantial parts thereof with a prism assembly mounted;

FIG. 9 is an enlarged view of substantial parts thereof;

FIGS. 10A and 10B show how to fix an adjusting member which is a frame fitted with an optical compensation plate in an embodiment of the present invention. FIG. 10A is an exploded perspective view showing how an adjusting member, which is a frame fitted with an optical compensation plate, and an adjusting member stopper, which is an auxiliary member, are to be mounted on a casing; and FIG. 10B is a perspective view showing a state in which an adjusting member is fixed to a casing by the use of an adjusting member stopper.

FIG. 11 is a top view showing specifically a state in which an adjusting member is inserted in a casing;

FIG. 12 is a side view of an adjusting member which is fitted with incident-side polarization plates and optical compensation plates;

FIG. 13 is an enlarged view of a relevant portion of an adjusting member shown in FIG. 12;

FIGS. 14A to 14C illustrate structures and operations of an adjusting member, to which a lens is fixed, according to an embodiment of the present invention;

FIG. 15A is a perspective view showing a polarization plate press-locking section according to an embodiment of the present embodiment; FIG. 15B is a perspective view showing how an inorganic polarization plate is press-locked in a polarization plate press-locking section; and FIG. 15C is an L-L cross-sectional view of FIG. 15B showing how an inorganic polarization plate is press-locked in a polarization plate press-locking section;

FIG. 16 is an exploded perspective view of a structure of a casing of an optical system according to an embodiment of the present invention;

FIGS. 17A to 17C are illustrations showing how a frame 63 bearing a lens is secured. FIG. 17A is a perspective view of a frame prior to its being slid, as viewed from diagonally above on a light-entering side; FIG. 17B is a perspective view of a frame having been slid from its position of FIG. 17A in a direction perpendicular to an optical axis, thereby forming auxiliary securing sections, as viewed from diagonally above on a light-outgoing side; and FIG. 17C is a perspective view as viewed from diagonally above on a light-entering side;

FIGS. 18A to 18C are each a perspective view showing a casing structure around an integrator lens. FIG. 18A is a perspective view showing a usage state of pressure contact members according to an embodiment of the present invention; FIG. 18B is an illustration of a pressure contact member, according to an embodiment of invention, as viewed in an M direction of FIG. 18A; and FIG. 18C is an illustration of a pressure contact member, according to an embodiment of the present invention, as viewed in an N direction of FIG. 18A;

FIGS. 19A to 19C illustrate structures and operations of a projection lens removal unit according to an embodiment of the present invention;

FIG. 20 is an exploded perspective view showing a projection lens mounting mechanism shown in FIGS. 19A to 19C;

FIG. 21 illustrates a major structure of a projection lens moving unit according to an embodiment of the present invention;

FIG. 22 is a block diagram showing a control mechanism of a projection lens moving unit according to an embodiment of the present invention;

FIG. 23 is a flowchart showing an exemplary procedure of controlling a movement limit; and

FIG. 24 is a flowchart showing another exemplary procedure of controlling a movement limit.

### DETAILED DESCRIPTION OF THE INVENTION

The present invention will now be described in detail based on preferred embodiments with reference to the accompanying drawings. This does not intend to limit the scope of the present invention, but to exemplify the invention.

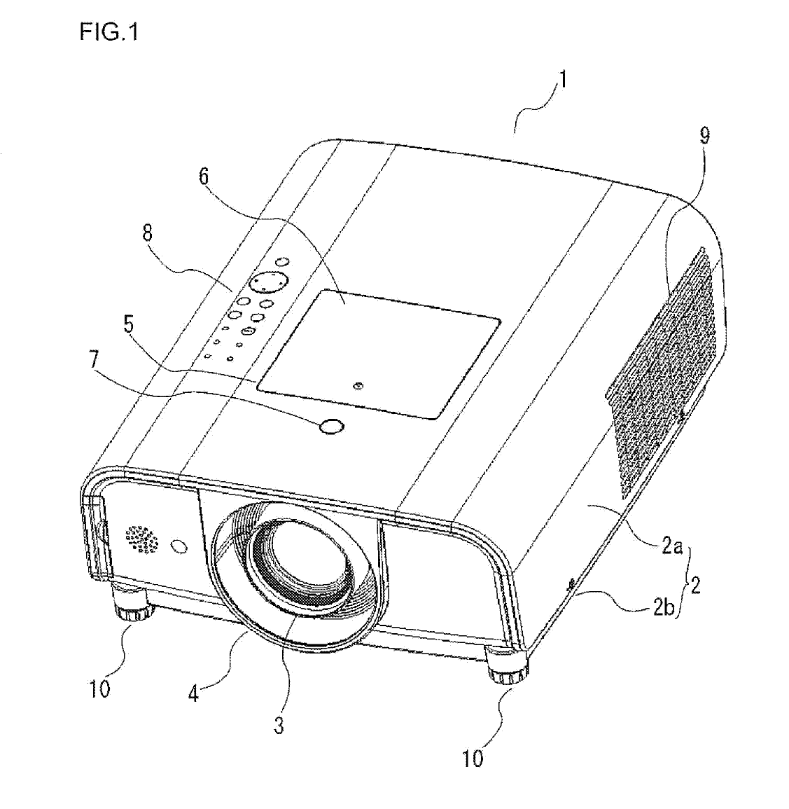

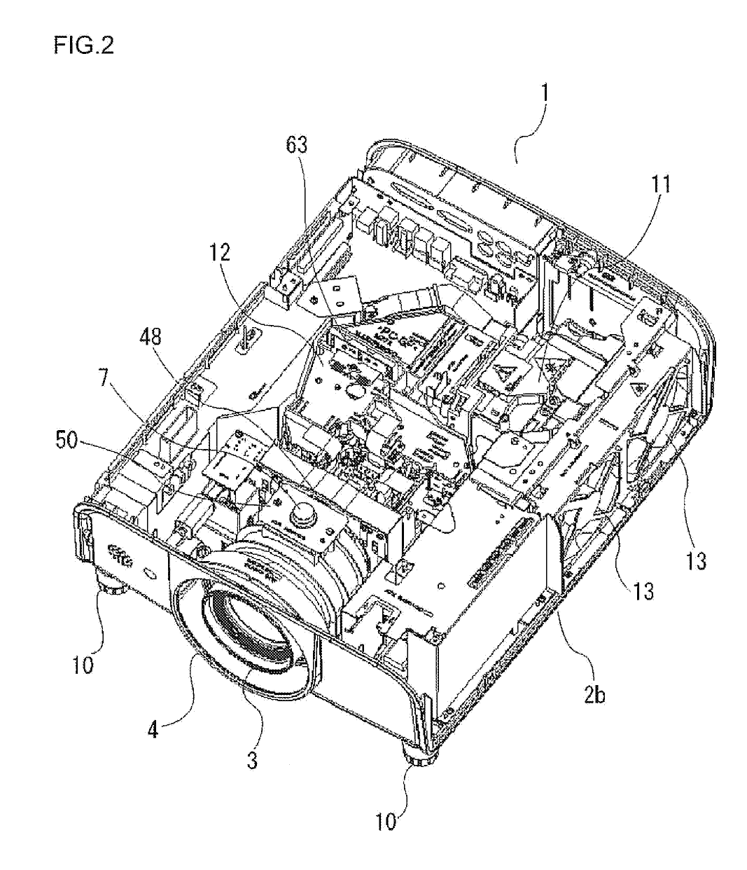

FIG. 1 is a perspective view showing a liquid crystal projector 1, which is a projection type image display apparatus, according to an embodiment of the present invention. FIG. 2 is a perspective view of a liquid crystal projector with top casing thereof removed.

As shown in FIG. 1, a body casing 2 forming a frame structure of this liquid crystal projector 1 is comprised of a top casing 2a and a bottom casing 2b. The interior of the liquid crystal projector 1 as shown in FIG. 2 becomes visible and exposed when the top casing 2a is removed.

A projection window 4 where a projection lens 3 is exposed is formed in a frontal center of the body casing 2. A maintenance opening 5, which is used for the purpose of maintenance, is formed in a top center of the body casing 2. An openable/closable lid 6 is provided in the maintenance opening 5. A projection lens release button 7, which is operated when the projection lens 3 is to be removed is exposed on a front side of the maintenance opening 5. And an operation display module 8 is provided to the left of the maintenance opening 5. Air holes 9 used to cool the internal parts of the liquid crystal projector 1 are formed in a right-hand rear part of a side surface thereof. Height-adjustable legs 10 and 10 are provided at opposite front ends of the bottom casing 2b.

As shown in FIG. 2, a light source unit 11 is disposed in a right rear position, as viewed from the front side, inside the body casing 2, and an optical system 12, which transmits the light from the light source 11 to the projection lens 3, is also disposed inside the body casing 2. Cooling fans 13 and 13, with which to cool the light source unit 11 and other components requiring the cooling, which face the air holes 9 shown in FIG. 1 are provided in the vicinity of the aforementioned light source unit 11.

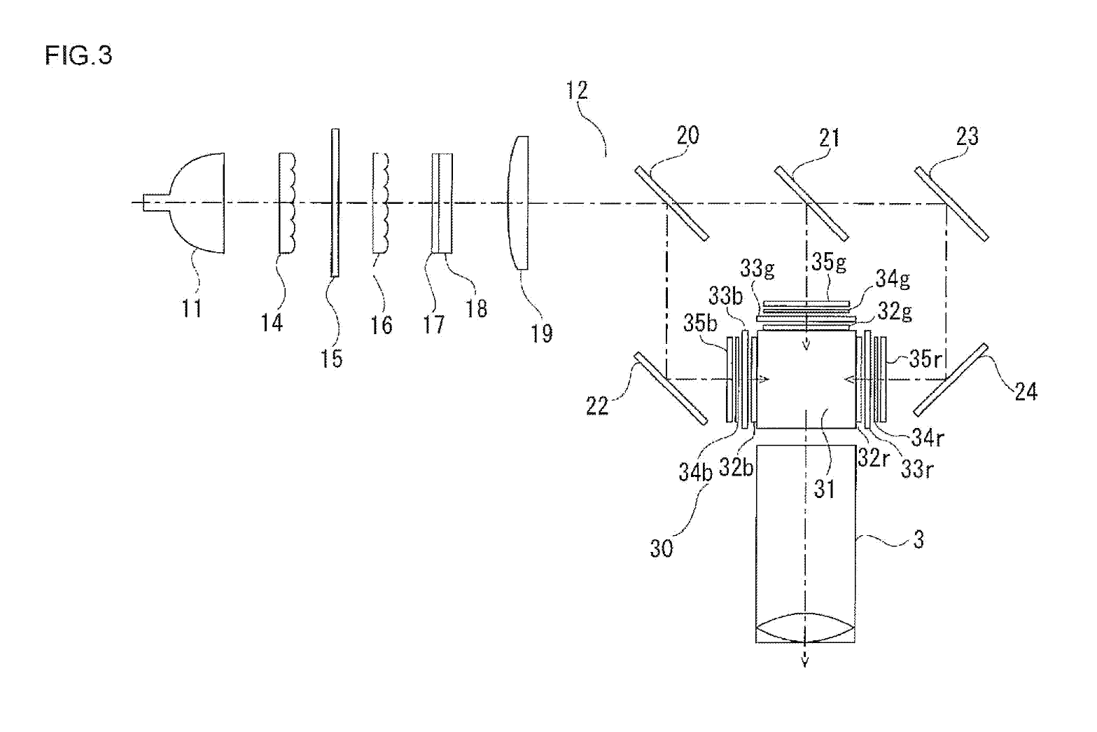

FIG. 3 illustrates an exemplary structure of the optical system 12. It should be noted here that the present embodiment is not limited to the optical system 12 as shown in FIG. 3 and the present embodiment may also be applicable to various types of other optical systems.

Referring to FIG. 3, a beam of white light emitted from the light source unit 11 is led to a first dichroic mirror 20 through a first integrator lens 14, a diaphragm mechanism 15, a second integrator lens 16, a slit plate 17, a polarizing beam splitter 18, a condenser lens (collective lens) 19 and the like.

The first integrator lens 14 and the second integrator lens 16 are each constructed of a fly eye lens. Here, the fly-eye lens, which is a heat-resistant glass, is formed such that a plurality of cells are arranged in a matrix. The first integrator lens 14 and the second integrator lens 16 have a function of uniformizing the illumination distribution of white light emitted from the light source unit 11. The slit plate 17, which is an aluminum thin plate, has a function of shielding unwanted incident light for the polarizing beam splitter 18. The polarizing beam splitter 18 has a function of extracting only either one of P-wave components and S-wave components of light.

The light that has passed through the polarizing beam splitter 18 reaches the first dichroic mirror 20 through the medium of the condenser lens 19. The first dichroic mirror 20 has a function of reflecting only blue components of the incident light and has also a function of passing red and green components thereof, whereas the second dichroic mirror 21 has a function of reflecting green components thereof and has also a function of passing red components thereof. As a result, the white light emitted from the light source unit 11 is dispersed into blue light, green light and red light by the first dichroic mirror 20 and the second dichroic mirror 21. The blue light reflected from the first dichroic mirror 20 is reflected by a field mirror 22 and then guided into an image generating apparatus 30. The green light reflected from the second dichroic mirror 21 is directly guided into the image generating apparatus 30. The red light that has passed through the second dichroic mirror 21 is reflected by field mirrors 23 and 24 and then guided into the image generating apparatus 30.

The image generating apparatus 30 is structured such that an LCD (Liquid Crystal Display) panel for red color 33r (hereinafter referred to as “red LCD panel 33r”), an LCD panel for green color 33g (hereinafter referred to as “green LCD panel 33g”), and an LCD panel for blue color 33b (hereinafter referred to as “blue LCD panel 33b”) are attached to three side surfaces of a cubic color synthesis prism 31, respectively, through the medium of three polarization plates 32r, 32g and 32b and the like. Optical compensation plates 34r, 34g and 34b, and polarization plates 35r, 35g and 35b, which are used to cut off unwanted components of incident light for the LCD panels 33r, 33g and 33b, respectively, are placed on light-entering sides of the three LCD panels 33r, 33g and 33b, respectively.

Thus, the blue light reflected by the first dichroic mirror 20 and the field mirror 22 is guided into the incident-side polarization plate 35b for blue color and is then led to the color synthesis prism 31 via the incident-side polarization plate 35b, the optical compensation plate for blue color 34b, the blue LCD panel 33b, the exit-side polarization plate for blue color 32b and so forth. Also, the green light reflected by the second dichroic mirror 21 is guided into the incident-side polarization plate for green color 35g and is then led to the color synthesis prism 31 via the incident-side polarization plate 35g, the optical compensation plate for green color 34g, the green LCD panel 33g and the exit-side polarization plate for green color 32g. Similarly, the red light, which has passed through the first dichroic mirror 20 and the second dichroic mirror 21 and which is reflected by the two field mirrors 23 and 24, is guided into the incident-side polarization plate for red color 35r and is then led to the color synthesis prism 31 via the incident-side polarization plate for red color 35r, the optical compensation plate for red color 34r, the red LCD panel 33r and the exit-side polarization plate for red color 32r.

The three-color image light guided into the color synthesis prism 31 are combined by the color synthesis prism 31, so that the color image light thus obtained thereby is magnified and projected onto a front screen through the projection lens 3.

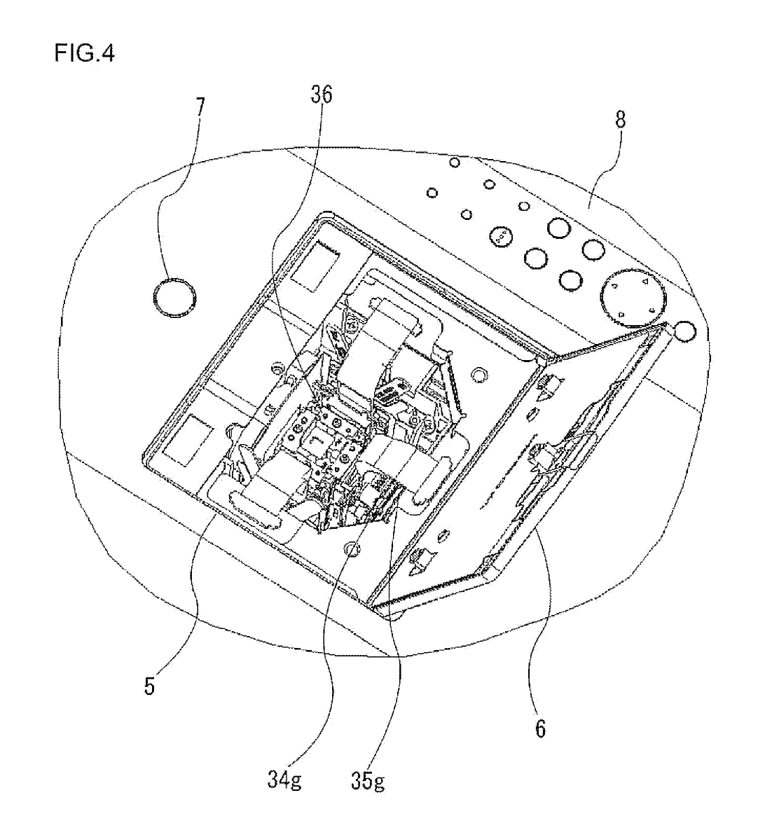

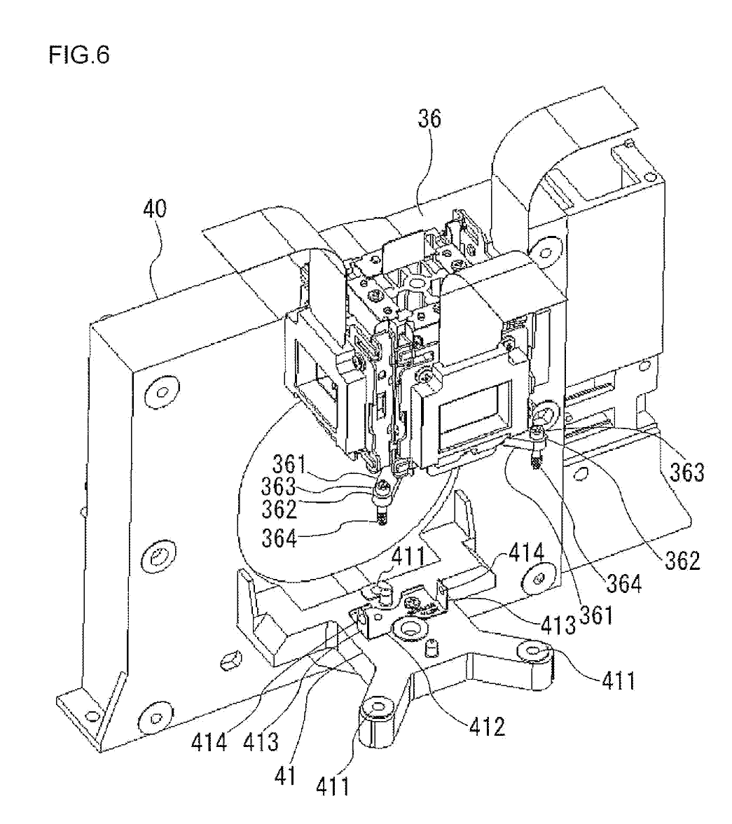

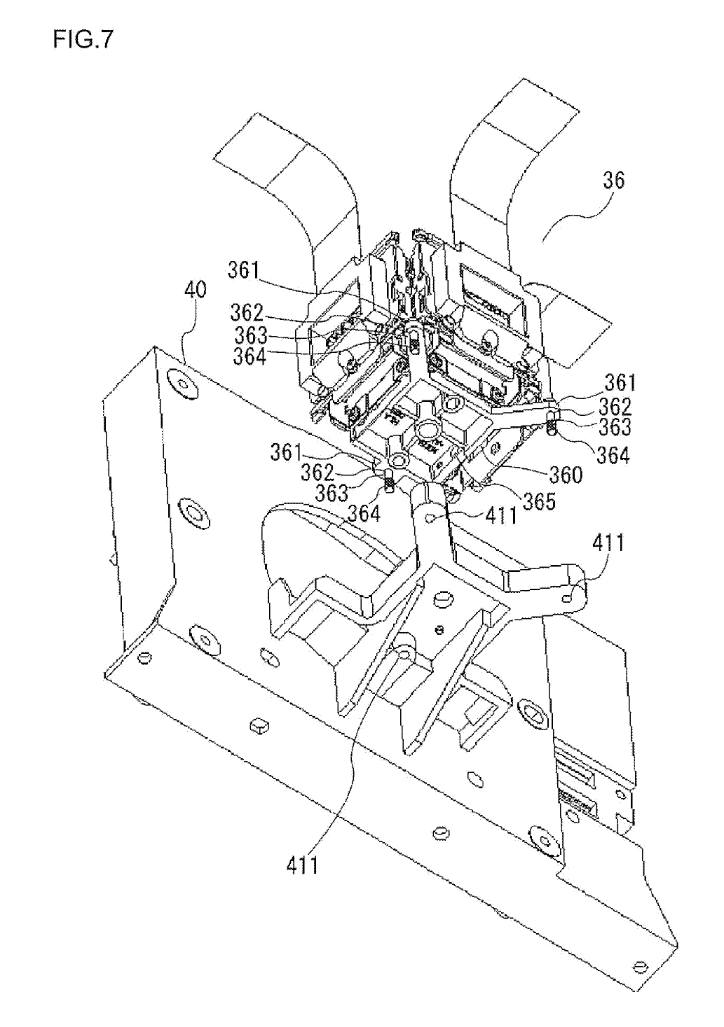

The color synthesis prism 31, the respective LCD panels 33r, 33g and 33b, the respective exit-side polarization plates 32r, 32g and 32b and so forth are structured integrally with one another as a unitized prism assembly 36 (See FIG. 6 and FIG. 7) and are also detachably mounted. Also, the incident-side polarization plates 35r, 35g and 35b and the optical compensation plates 34r, 34g and 34b are structured in an individually detachable manner. As illustrated in FIG. 4, the prism assembly 36, the incident-side polarization plates 35r, 35g and 35b and the optical compensation plates 34r, 34g and 34b are directly accessible for maintenance purposes if the lid 6 in the maintenance opening 5 is opened.

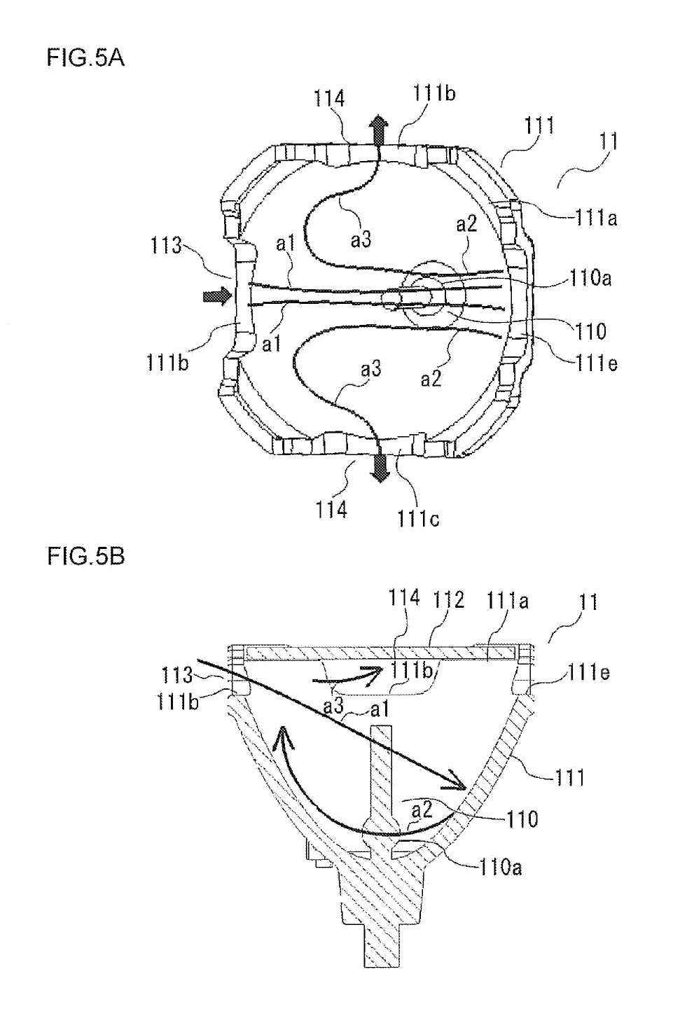

FIGS. 5A and 5B illustrate a major structure and an operation of the light source unit 11 according to the present embodiment. FIG. 5A is a perspective view of a front opening of the light source unit 11 as viewed from a slightly right-side position. FIG. 5B is a vertical cross-sectional view, and the arrows in FIG. 5B indicate the flow of cooling air.

The light source unit 11 according to the present embodiment includes an arc tube 110 formed of a high-pressure mercury lamp or the like, a reflector 111 which is so placed as to cover the arc tube 110 wherein a parabolic reflecting surface is formed on an inner surface thereof and there is an opening in the front thereof, and a transparent heat-resistant glass plate 112 which covers and blocks a front opening 111a of the reflector 111. In a base side of the arc tube 110, there is provided a light-emitting part 110a, of an approximately spherical shape, which contains discharge electrodes for emitting light.

As shown in FIG. 5A, the reflector 111 has four notched portions 111b to 111e, for ventilation purposes, formed in the opposing horizontal and vertical sides thereof along the periphery of the front opening so that the notched portions 111b to 111e can be spaced apart with equal angles of 90 degrees apart from each other. In the present embodiment, the notched portion 111d on the left-side surface on the periphery of the front opening in the reflector 111 serves as an air inlet 113, whereas the notched portion 111e (on the right-side surface thereon) disposed counter to the air inlet 113 is blocked. Also, the opposing notched portions 111b and 111c (on the upper- and lower-side surfaces thereon) serve as air outlets 114 and 114.

In this manner, the two air outlets 114 and 114 are each located at approximately 90 degrees apart from the air inlet 113, so that the cooling air flowing to an tip end of the arc tube 110 hits an opposing face disposed counter to the air inlet 113 as indicated by arrows a1. Since the notched portion 111e and the front opening 111a on the opposing face disposed counter thereto are blocked, the cooling air flows past the light emitting part 110a of the arc tube 110 toward the back as indicated by arrows a2 and then flows toward the air outlets 114 and 114 on both sides as indicated by arrows a3. As a result, the cooling air cools uniformly the regions surrounding the arc tube 110 without being stayed on inside the reflector 111. The arrangement as described above allows the uniform cooling of the interior of the reflector 111, at low cost, even in the case where the light source unit 11 is installed in a position at an arbitrary angle.

As described above, the cooling air is circulated throughout the entire interior of the reflector 111 of the light source unit 11 without being stayed on therein. Hence, the temperature of the arc tube 110 is easily adjusted, and the cooling effect at the tip end of the arc tube 110 and near the light emitting part 110a and the front opening 111a of the reflector 111 is enhanced. This enables the light source unit 11 to be installed at an arbitrary angle, thus realizing the low cost manufacturing thereof and eliminating the angular limitation set forth in the installation of the liquid crystal projector 1.

Also, since the air outlets 114 and 114 are located on the both sides with approximately 90 degrees apart from the air inlet 113, respectively, the air outlets 114 and 114 are located circularly midway between the air inlet 113 and its opposite face. Thus, the cooling effect proves very efficient in that the cooling air is circulated throughout the entire interior of the reflector 111 of the light source unit 11 without causing the cooling air to stay on therewithin.

As described above, the air outlets 114 and 114 are placed on the both sides with about 90 degrees away from the air inlet 113. However, the present embodiment is not limited thereto. The air outlets may be placed on the both side, with any other degrees than 90 degrees, apart from the air inlet 113. Even in a modification employing a different arrangement where any other degrees than 90 degrees is set, a certain level of the similar advantageous effect is still achieved as long as the air outlets 114 and 114 are provided on the both sides.

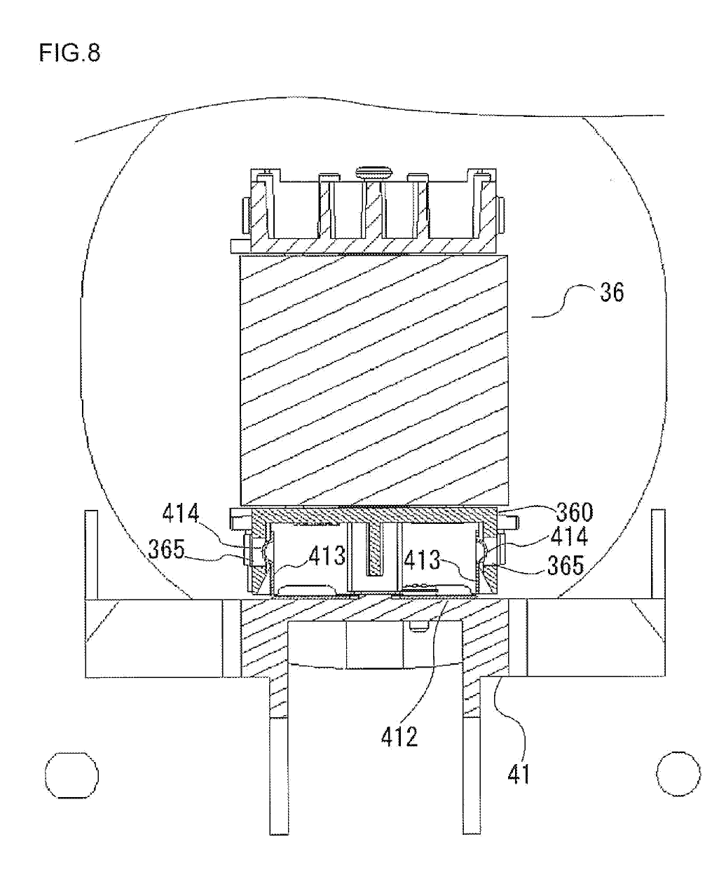

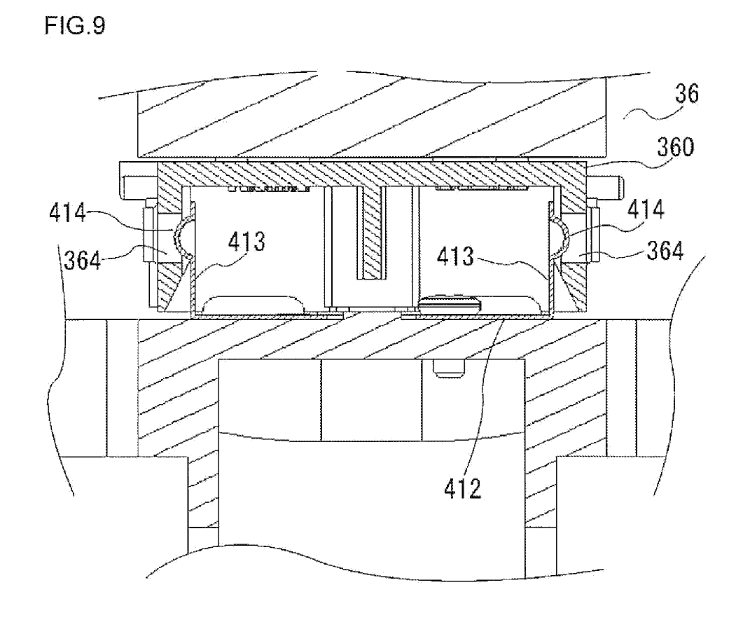

FIG. 6 to FIG. 9 each illustrates how the aforementioned prism assembly 36 is mounted. FIG. 6 is an exploded perspective view of the prism assembly 36 as viewed obliquely from top. FIG. 7 is an exploded perspective view thereof as viewed obliquely from below. FIG. 8 is a vertical cross-sectional view showing substantial parts thereof with the prism assembly 26 mounted. FIG. 9 is an enlarged view of the substantial parts thereof.

The prism assembly 36 is secured to a mount section 41 as follows. That is, fixing screws 363 are inserted in screw through-holes 362 of legs 361 projecting in three directions from a base 360 of a bottom of the prism assembly 36, and are tightened into female screw portions 411 of the mount section 41 overhung from a base section 40 that houses a projection lens moving unit which will be discussed later.

A pair of engagement members 413, disposed apart from each other at a predetermined distance therebetween, are provided upright from an elastic member 412, such as a flat spring, on the mount section 41. A semi-spherical protrusion 414 protruding outwardly is formed on each of the engagement members 413.

On the other hand, a bottom face side of the base 360 of the prism assembly 36 is hollowed out to have a hollow space, and engagement bores 365, engaged elastically with the protrusions 414 of the respective engagement members 413, are formed on opposing inner walls that defines the hollow space.

It is to be noted here that a pair of engagement members 413 and 413 on a mount section 41 side are provided upright at a distance apart from each other equal to the distance between the inner walls on which the engagement bores 365 on a base 360 side of the prism assembly 36 are formed. Also, the engagement members 413 and 413 are elastic enough to allow them to be detachable when the prism assembly 36 comes under a force exceeding its own weight.

Further, a male screw portion 364, the only tip end of which is to be engaged and screwed with the female screw portion 411 on a mount section 41 side, is formed on the fixing screw 363. The screw through-hole 362 on a prism assembly 36 side is so formed as to be smaller in diameter than the male screw 364 of the fixing screw 363. Also, formed in the screw through-hole 362 is a female screw portion (not shown) which is penetrated by the male screw portion 364 engaged and screwed therewith.

In the above-described structure, when the prism assembly 36 is to be mounted, the base 360 of the prism assembly 36 is pressed into a predetermined position of the mount section 41. Then, as shown in FIG. 8 and FIG. 9, the protrusion 414 of the engagement member 413 in the mount section 41 is in elastic engagement with the engagement bore 365 on a base 360 side, so that the prism assembly 36 is temporarily held in position with the mount section 41. In this state, when the fixing screw 363 threaded through the screw through-hole 362 on the prism assembly 36 side is tightened with the female screw portion 411 on a mount section 41 side, the prism assembly 36 is secured to the mount section 41.

A description will now be given of an instance where the prism assembly 36 is dismounted from a liquid crystal projector 1 installed upside down hung from a ceiling. In this case, as shown in FIG. 4, the lid 6 of the maintenance opening 5 is opened first, and then the fixing screw 363 of the prism assembly 36 is removed by rotation from the female screw portion 411 of the mount section 41 using a screw driver. Even if all the fixing screws are removed without holding the prism assembly 36 by hand, the prism assembly 36 is temporarily secured in position by the engagement members 413 by the elastic forces exerted by engagement members 413, which exceed the weight of the prism assembly 36, and therefore the prism assembly 36 will not fall off. With all the fixing screws 363 of the prism assembly 36 removed, the prism assembly 36 can be easily removed by pulling it by hand. Thus, it is possible to replace the prism assembly 36 quite easily while leaving the liquid crystal projector 1 upside down as it is. And this facility greatly improves the working efficiency for the maintenance.

Further, even when the fixing screws 363 are removed from the female screw portions 411 of the mount section 41 using the driver, they will not removed from the screw through-holes 362 of the prism assembly 36. This saves the trouble of removing any of the fixing screws 363 from the driver and allows the next removal of the fixing screws 363, so that the working efficiency further improves.

The above-described technique is applied to the prism assembly 36 where the LCD panels 33r, 33g and 33b for RGB colors, the exit-side polarization plates 32r, 32g and 32b and the like are formed integrally with the color synthesis prism 31. As a result, the parts and components can be replaced easily while leaving the liquid crystal projector 1 upside down suspended from a ceiling, without worrying about its fall-off therefrom. And this is a significant advantageous effect of the present embodiment.

With the liquid crystal projector 1 constructed as described above, the parts and components can be replaced easily even when the projector is installed upside down on a ceiling. As a result, a liquid crystal projector 1 featuring a significantly improved maintenance efficiency can be realized.

In the present embodiment, the elastic engagement members 413 are formed on the mount section 41 side, and the engagement bores 365 with which the protrusions 414 of the engagement members 413 are engaged are formed on the prism assembly 36 side. However, the situation may be reversed. That is, the above-described advantageous effect is achieved as long as at least either one of engagement parts is elastic.

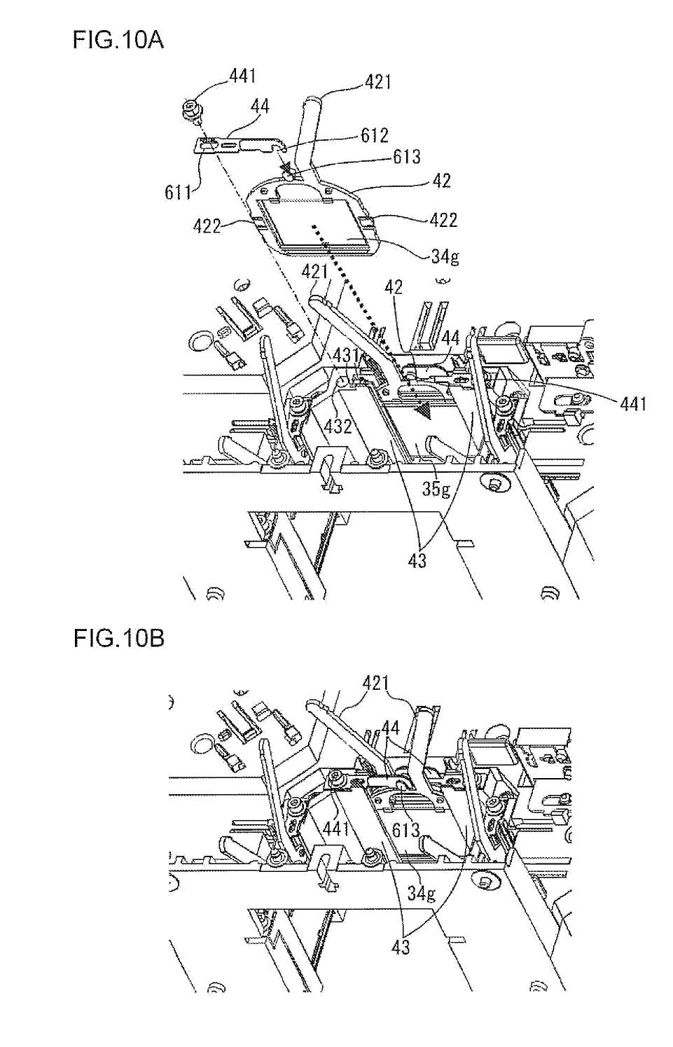

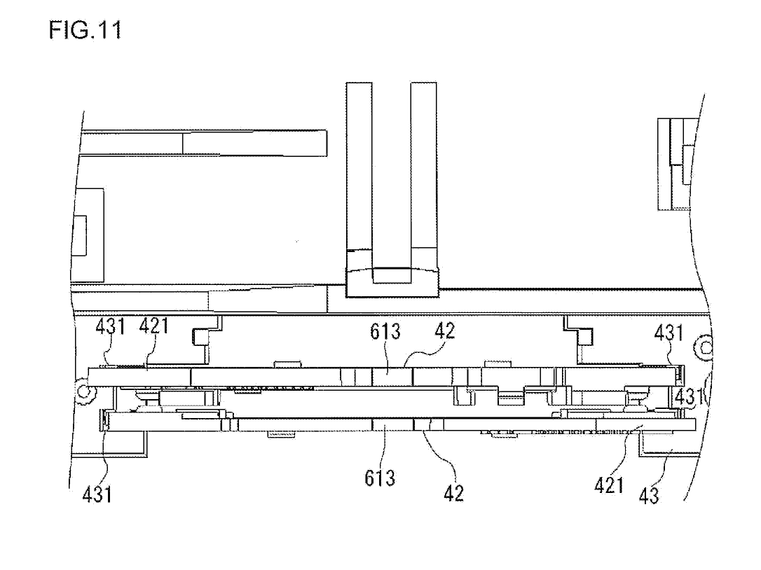

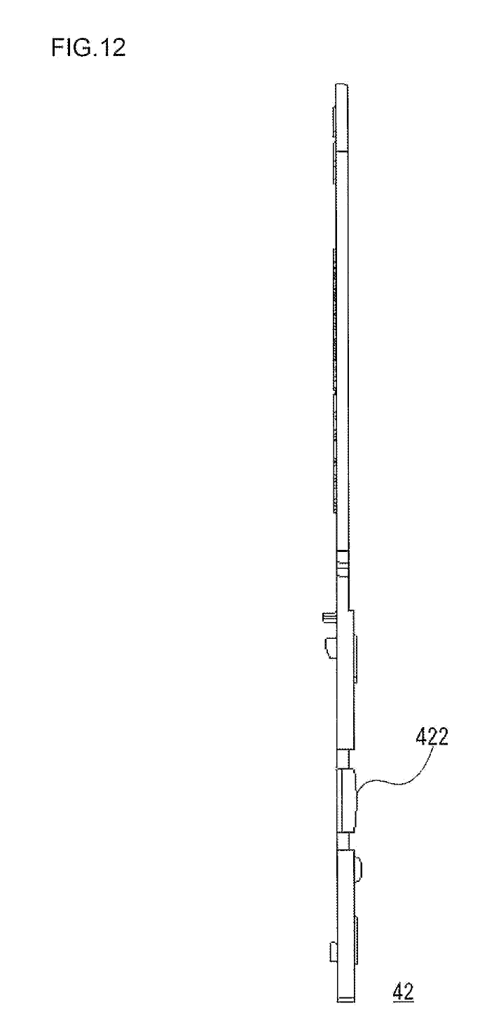

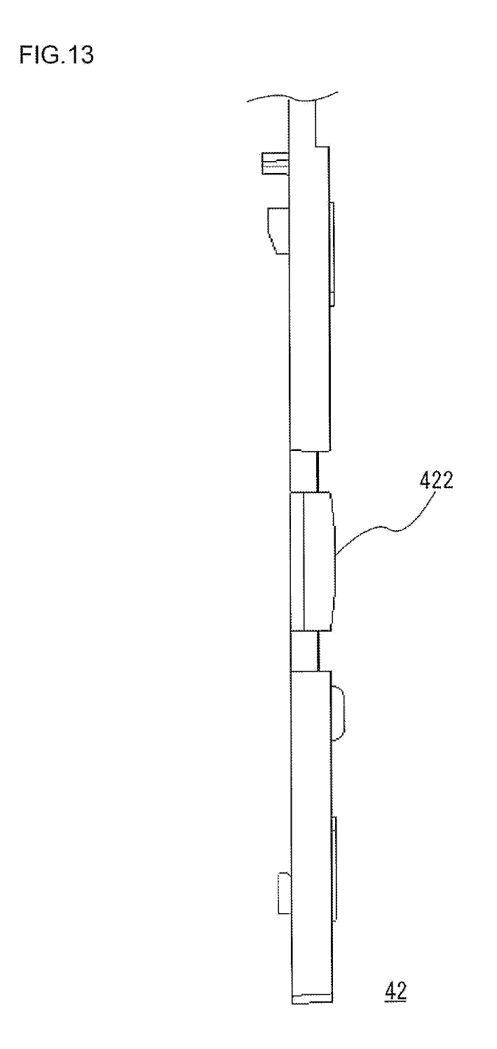

FIGS. 10A and 10B through FIG. 13 are illustrations showing how the incident-side polarization plates 35r, 35g and 35b and the optical compensation plates 34r, 34g and 34b are mounted. FIGS. 10A and 10B show how to fix an adjusting member 42, which is a frame fitted with an optical compensation plate 34g, in the present embodiment. FIG. 10A is an exploded perspective view showing how the adjusting member 42, which is a frame fitted with an optical compensation plate 34g, and an adjusting member stopper 44, which is an auxiliary member, are to be mounted on the casing. FIG. 10B is a perspective view showing a state in which the adjusting member 42 is fixed to the casing by the use of the adjusting member stopper 44. FIG. 11 is a top view showing specifically a state in which the adjusting member 42 is inserted in the casing. FIG. 12 is a side view of an adjusting member 42 which is fitted with incident-side polarization plates 35r, 35g and 35b and optical compensation plates 34r, 34g and 34b. FIG. 13 is an enlarged view of a relevant portion of the adjusting member 42 shown in FIG. 12. Here, only the optical compensation plate 34g for green light and the adjusting member stopper 44 will be described as an example, but similar descriptions will apply to those of the polarization plates for red and blue lights.

As shown in FIG. 10A, the incident-side polarization plate 35g and the optical compensation plate 34g are mounted on the adjusting member 42. The adjusting member 42 is an approximately disk-shaped resin frame which has a total of four rounded upper and lower corners. The lateral edges of the adjusting member 42 are inserted in the respective mounting grooves 431. The mounting grooves 431, which are formed in the opposing walls of a mount section 43, have lower end portions slightly rounded (not shown) such that the inserted adjusting member 42 can rotate. The mounting grooves 431 according to the present embodiment are separate from each other in the lower portion, but they may be formed as a single groove connecting the right and left parts.

In this embodiment, two engagement members 422 of a resilient resin, which are each slightly outwardly curved, are formed in the middle part of each lateral edge of the approximately disk-shaped adjusting member 42 (see FIGS. 12 and 13 also). The engagement members 422 are elastic enough to allow the adjusting member 42 holding the incident-side polarization plate 35g and the polarization plate 34g to be detached when it comes under a force exceeding its own weight. Also, the outwardly curved surfaces of the engagement members 422 are formed substantially in an arc as shown in FIGS. 12 and 13 such that they may not interfere when the adjusting member 42 is inserted into the mounting grooves 431 in the mount sections 43.

In this arrangement, the adjusting member 42 with an incident-side polarization plate 35r, 35g or 35b and an optical compensation plate 34r, 34g or 34b can be mounted as it is first inserted into the mounting grooves 431 of the corresponding mount section 43 and then pushed in against the elasticity of the engagement members 422. As a result, as exemplified by the adjusting member 42 bearing thereon the polarization plate 35g as shown in FIG. 10, the adjusting member 42 is temporarily held in position with the engagement members 422 in elastic engagement with the mounting grooves 431 of the corresponding mount section 43.

After the adjustment member 42 is inserted in the mounting grooves 431, the adjusting member 42 is fixed to the casing by means of the adjusting member stopper 44. More specifically, a second securing portion 613 (see FIG. 11 also), a round projection provided on an upper surface of the adjusting member 42 as a frame-side positioning section, is held down by a semi-circular notch 612 in the adjusting member stopper 44, which is a second part of the auxiliary member, in such a manner that a second securing portion 613 is enveloped from right and left as well as from above. At the same time, a first securing portion 611 provided at the other end of the adjusting member stopper 44, which is the first part of the auxiliary member, is secured temporarily by provisionally tightening a fixing screw 441 in a screw mount section 432 provided in the upper surface of the mount section 43. Next, the angle of the optical compensation plate 34g is adjusted within a play of the first securing portion 611 by rotating a handgrip 421, provided on the upper part of the adjusting member 42, for use in mounting the frame on the casing and rotation adjustment. After the adjustment, the fixing screw 441 is tighten up into the screw mounting section 432 such that the adjusting member 42 bearing thereon the incident-side polarization plate 35g and the optical compensation plate 34g is fixed securely to the casing (see FIG. 10B).

There have actually been known arrangements in which the polarization plates are adjusted by rotating the adjusting member. In such arrangements, for instance, the adjusting member is screwed directly or the projection on the adjusting member is held down to prevent it from rotating. However, when the adjusting member is screwed with direct pressure applied by means of an auxiliary member, there occurs a problem of the adjusting member rotating. Another problem is that, at the end of tightening the screw, the adjusting member tends to move in the same direction as tightening, thus distorting the optical axis. In the present embodiment, on the other hand, securing with the fixing screw 441 is done through the medium of an auxiliary member 44 so that the adjusting member 42 is subject to minimal downward force perpendicular to the optical axis only. Thus, the angle of the polarization plate can be adjusted accurately and easily without the post-adjustment movement of the adjusting member 42 in the process of screw tightening.

A description will now be given of an instance where the adjusting member 42 having an incident-side polarization plate 35r, 35g or 35b and an optical compensation plate 34r, 34g or 34b thereon is dismounted from the liquid crystal projector 1 installed upside down hung from a ceiling. In this case, as shown in FIG. 4, the lid 6 of the maintenance opening 5 is opened first, and then the adjusting member stopper 44 is removed by taking out the fixing screw 441 of the adjustment member stopper 44 using the screw driver. Since the adjusting member stopper 44 is secured by only one fixing screw 441, it can be easily removed by holding the handgrip 421. With the adjusting member stopper 44 removed, however, the adjusting member 42 with the incident-side polarization plate 35g and the optical compensation plate 34g mounted thereon will not fall off but will be temporarily secured in position by the elastic forces exerted by the engagement members 422, which exceed the weight of the adjusting member 42. Nevertheless, after the adjusting member stopper 44 is removed, the adjusting member 42 can be easily dismounted by hand by pulling the handgrip 421 of the adjusting member 42. Thus, it is possible to replace any one of the incident-side polarization plates 35r, 35g and 35b and the optical compensation plates 34r, 34g and 34b quite easily without losing the adjustment function while leaving the liquid crystal projector 1 installed upside down as it is. And this facility greatly improves the working efficiency for the maintenance.

Also, the planar adjusting members 42, made of a resin, having the incident-side polarization plates 35r, 35g and 35b and the optical compensation plates 34r, 34g and 34b mounted thereon have engagement members 422 thereon, which are in pressured engagement with the mounting grooves 431 of the mount section 43 by the use of the elasticity of the resin. Accordingly, the incident-side polarization plates 35r, 35g and 35b and the optical compensation plates 34r, 34g and 34b can be maintained quite easily at low cost.

With the liquid crystal projector 1 constructed as described above, the polarization plates may be fixed after the adjustment of the angle thereof without losing the adjusted state. Also, the parts and components can be replaced easily even when the projector is installed upside down on a ceiling. As a result, a liquid crystal projector 1 featuring an improved maintenance efficiency can be realized.

Although the present embodiment has been described with a particular reference to a technology applicable to the incident-side polarization plates 35r, 35g and 35b and the optical compensation plates 34r, 34g and 34b, it will be apparent to those skilled in the art that the present embodiment can also be applied in a similar manner to any optical components that are mounted by the use of the adjusting members.

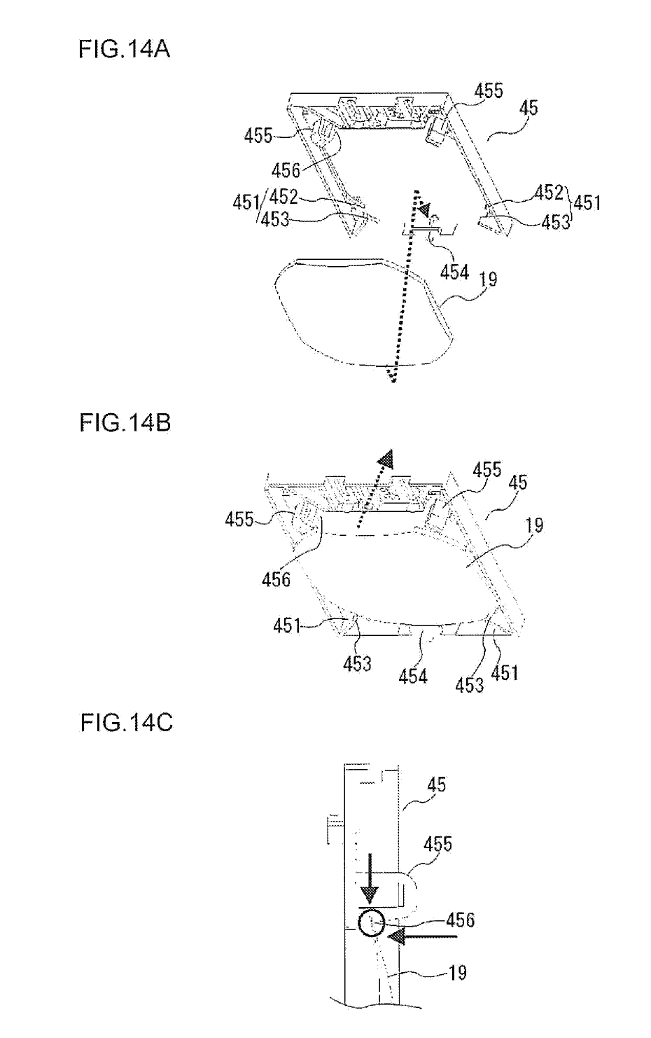

FIGS. 14A to 14C illustrate structures and operations of an adjusting member to which a lens is fixed. A description will be given here using a condenser lens 19 shown in FIG. 3.

An adjusting member 45, which is a rectangular frame body formed of a resin, has at two lower corners thereof two positioning fitting parts 451 and 451 by which both ends at one side of the periphery (a lower position in FIG. 14) of the condenser lens 19 are fit and position-aligned. Each positioning fitting part 451 includes a wall 452 on the back side and a catch 453 on the front side. A front-side catch 454 only is formed midway between these positioning fitting parts 451 and 451.

On the other hand, formed at the two upper corners of the adjusting member 45 are elastic fitting parts 455 and 455 which are fit elastically to both upper ends of the periphery of the condenser lens 19 whose lower sides are fit to the positioning fitting parts 451. The elastic fitting parts 455 are disposed upright on the frame body 45 and are inwardly curved in an approximately U-shaped form. In the elastic fitting parts 455, catches 456 are formed on inner parts which are elastically deformable.

In the above-described arrangement, when the condenser lens 19 is to be mounted on the adjusting member 45, one side (lower side) of the condenser lens 19 is first inserted between the wall 452 and the catch 453 of each of the positioning fitting parts 451 and 451, as shown in FIG. 14A. Then, as shown in FIG. 14B, the other side (upper side) of the condenser lens 19 is slidably pressed against the elastic fitting parts 455 and 455 disposed on the upper side of the adjusting member 45.

This causes the both ends of the condenser lens 19 on the upper side thereof to be fit to the catches 456 of the elastic fitting parts 455, as shown in FIG. 14C. Thus, a tension is applied in the directions as indicated by arrows in FIG. 14C and the condenser lens 19 is completely fixed in the proper position.

On the other hand, when the condenser lens 19 is to be dismounted from the adjusting member 45, the two elastic fitting parts 455 are elastically deformed outwardly so as to cancel the state of catches 456 being fit to the condenser lens 19. In this manner, the condenser lens 19 can be easily removed from the adjusting member 45.

As described above, the number of components needed for the fixing of the lens can be minimized to as small as a single component. The reduced number of components needed achieves an increased working efficiency and brings about cost reduction. Further, the investment in dedicated facilities such as welding equipment for fixing the lens is no longer needed. Also, the adjusting member 45 and the condenser lens 19 both become reusable.

Also, the adjusting member 45 is formed of a resin and the elastic fitting part 455 is formed by the use of the elasticity of the resin, so that further cost reduction can be achieved.

With the liquid crystal projector 1 constructed using the technology as described above, achieved is the liquid crystal projector 1 that realizes the increased working efficiency and the cost reduction and requires no special facility such as one for the welding, wherein the adjusting member 45 and the condenser lens 19 both become reusable.

It is to be noted that a lens to be employed in the present embodiment is not limited to the condenser lens 19 and various types of lenses may be employed as long as it is secured to the adjusting member. For example, though not shown in the optical system of FIG. 3, a relay lens is generally used to adjust the difference of the optical path lengths for the RGB colors. Since this relay lens is securely mounted on the adjusting member, the above-described technology is applicable thereto.

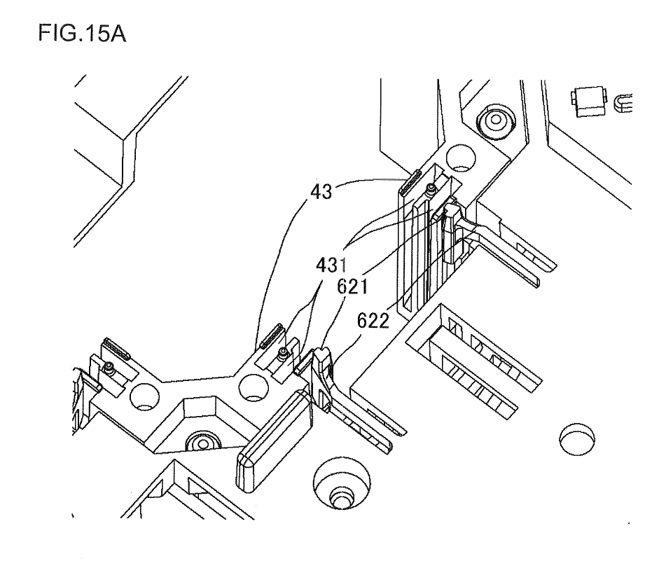

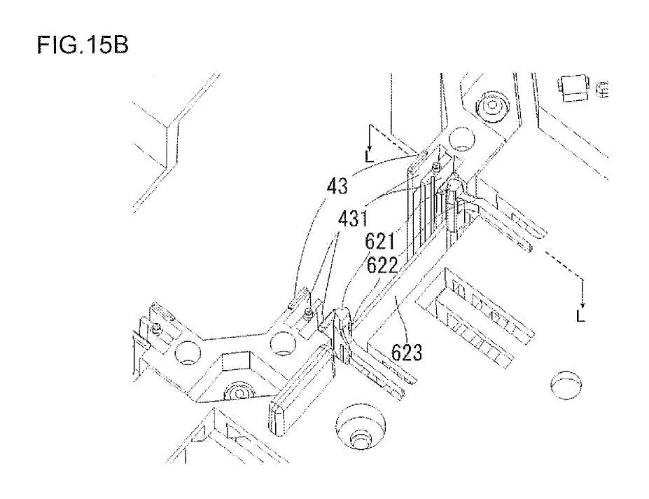

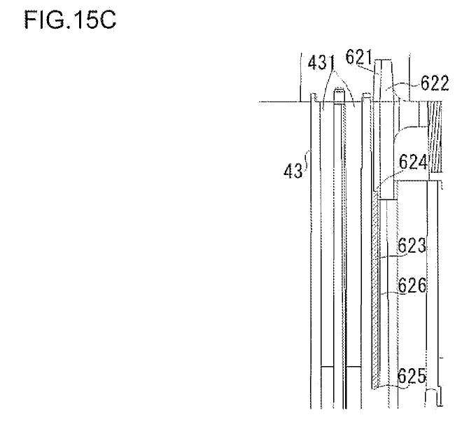

FIG. 15A is a perspective view showing a polarization plate press-locking section according to the present embodiment. FIG. 15B is a perspective view showing how an inorganic polarization plate 623 is press-locked in the polarization plate press-locking section according to the present embodiment. FIG. 15C is an L-L cross-sectional view of FIG. 15B showing how the inorganic polarization plate 623 is press-locked in the polarization plate press-locking section according to the present embodiment.

Most of the components around the color synthesis prism 31 have short service lives and thus require frequent replacements. Hence, the projection type image display apparatus according to the present embodiment is so structured as to allow easy access to and replacement of those components once the lid 6 is opened. The inorganic polarization plate 623 in the present embodiment is one of those short-lived components. Therefore, it is preferable that the inorganic polarization plate 623 has a structure that allows easy and safe replacement once the lid is opened without any further opening and closing of the lid. However, it is not desirable that many components are added in order to realize such a structure.

Thus, in the present embodiment, as illustrated in FIG. 15A, the inorganic polarization plate 623 is replaced and locked using the resilience of resin arms 622 which are integrally formed with a lid. A procedure for the mounting of the inorganic polarization plate 623 is as follows. First, an end portion of the inorganic polarization plate 623 is pressed against L-shaped guide grooves 621 provided in the arms 622, which serve as the guide for the insertion of the inorganic polarization plate 623. Then the inorganic polarization plate 623 is slid downward in the inorganic polarization plate groove 626, which is a groove where the polarization plate is inserted (FIG. 15C). The inorganic polarization plate 623 is further inserted until a lower end thereof hits the bottom of the inorganic polarization plate groove 626. Next, the arms 622 are raised and placed above the inorganic polarization plate 623, and then the inorganic polarization plate 623 is press-locked to the casing by the arms 622 (FIG. 15C).

The arms 622 are located lower (not shown) when the inorganic polarization plate 623 is not locked (FIG. 15A) than when it is locked as shown in FIGS. 15B and 15C. That is, when the inorganic polarization plate 623 is locked, the arms 622 are pushed up higher than usual, so that; as shown in FIG. 15C, the arms 622 push obliquely down an upper end of the inorganic polarization plate 623 at an upper locking portion 624 by an elastic force from the light-entering side. Also, as shown in FIG. 15C, a lower end portion of the inorganic polarization plate groove 626 having the inorganic polarization plate 623 inserted therein is notched on the light-entering side and narrower to form the lower locking portion 625. The structure as described above makes it possible to lock the inorganic polarization plate 623 both vertically and horizontally by pressing it against the side face on the light-outgoing side of the mount section 43.

The inorganic polarization plate 623 according to the present embodiment is made by vapor-depositing a metal on a glass substrate. An example is one with the brand name of ProFlux sold by Polatechno Co., Ltd. This product should be handled with care because touching the surface of the polarization plate with a finger will cause oxidation, which renders it useless as a polarization plate. Hence, when mounting the inorganic polarization plate 623 on the casing, care should be taken by holding the inorganic polarization plate 623 by its side faces, for instance. The present embodiment employs a simple locking method of the inorganic polarization plate 623, in which guide grooves 621 are provided in the arms 622 and the resilience of the arms 622, which are integrally formed with the casing, is used. As a result, it is possible to fit the inorganic polarization plate 623 in the inorganic polarization plate groove 626 quite easily without touching the surface of the inorganic polarization plate 623.

Furthermore, the inorganic polarization plate 623 can be dismounted easily by raising the arms 622 with a force exceeding the resilient force and opening them outward. Accordingly, the structure as described above allows easy replacement of the inorganic polarization plate 623 simply by opening the lid 6 without introduction of any additional components. Thus, the inorganic polarization plate 623 can be locked or replaced using the simple structure, which in turn brings about cost reduction.

Even when the liquid crystal projector 1 is installed upside down suspended from a ceiling, the inorganic polarization plate 623, which is locked by the arms 622, will not fall off. Nevertheless, the inorganic polarization plate 623 can be dismounted by simply moving the arms 622 with a force exceeding the resilient force thereof. Thus, it is possible to replace the inorganic polarization plate 623 quite easily while leaving the liquid crystal projector 1 suspended from the ceiling. And this facility greatly improves the efficiency of the maintenance work.

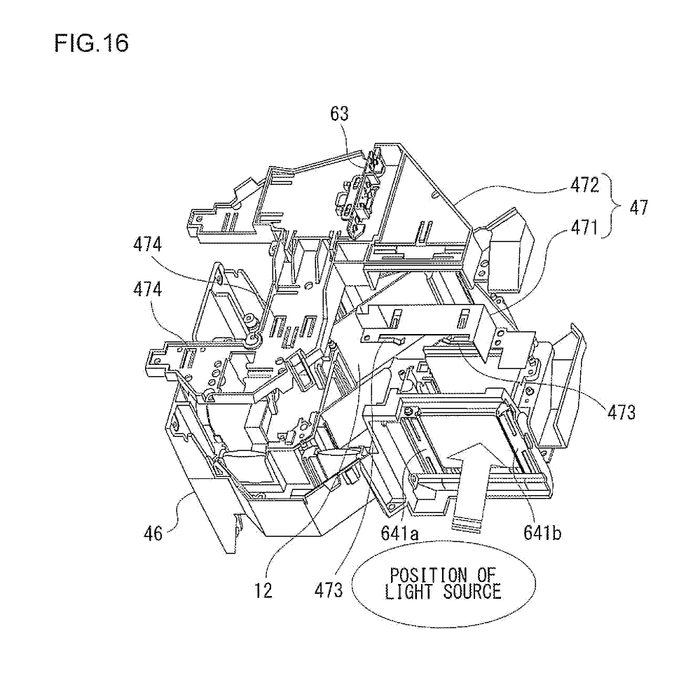

FIG. 16 is an exploded perspective view showing a structure of a casing of an optical system.

An optical system 12 according to the present embodiment is housed in an optical system storage 46 formed of a heat-resistant resin with little thermal shrinkage and having an opening in the upper surface thereof, and the opening in the upper surface of the optical system storage 46 housing the optical system 12 is covered by a lid 47.

Conventionally, such a lid is formed entirely of a heat-resistant resin. In the present embodiment, the lid 47 is constituted by a lid 471 made of a sheet metal and an elastic resin lid 472, which is not heat-resistant, wherein the sheet-metal lid 471 is used in a high-temperature region close to the light source and the resin lid 472 is used in a low-temperature region at a certain distance away from the light source. More specifically, the sheet-metal lid 471 covers above the first integrator lens 14 shown in FIG. 3, so that only a minimal area is needed as shown in FIG. 16.

A structure is such that the dimensional tolerances of the optical components housed in the optical system storage 46 are absorbed by simple spring structures 473 and 474 which are so formed as to cut out a part of the sheet-metal lid 471 and the resin lid 472, respectively.

As already described above, the sheet-metal lid 471 is used in the high-temperature region of the optical system 12 and the resin lid 472 is used in the low-temperature region thereof, so that the dimensional tolerances of the optical components are absorbed by their respective resiliencies and they can be fixed reliably.

This makes it unnecessary to use additional parts for fixing the optical components. As a result, the number of components and the number of processes in fabrication can be reduced. Further, an expensive heat-resistant resin is not used for the lid 47, thus realizing a significant cost reduction.

Also, since the dimensional tolerances of the optical components contained in the optical system storage 46 are absorbed by the simple spring structures 473 and 474 which are so formed as to cut out a part of the sheet-metal lid 471 and the resin lid 472, the structure can be achieved with ease.

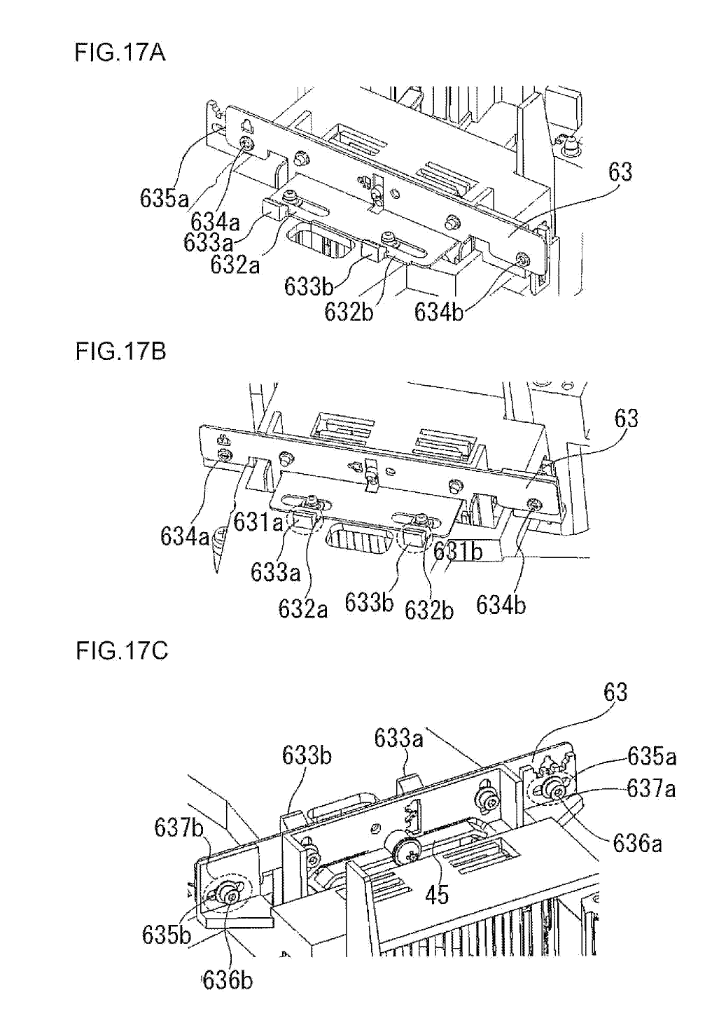

FIGS. 17A to 17C are illustrations showing how a frame 63 bearing a lens is secured. FIG. 17A is a perspective view of a frame 63 prior to its being slid, as viewed from diagonally above on the light-entering side. FIG. 17B is a perspective view of the frame 63 having been slid from its position of FIG. 17A in a direction perpendicular to the optical axis, thereby forming auxiliary securing sections 631a and 631b, as viewed from diagonally above on the light-outgoing side. FIG. 17C is a perspective view as viewed from diagonally above on the light-entering side.

The frame 63 having optical components mounted thereon requires adjustment in the horizontal direction perpendicular to the optical axis. For this adjustment, the frame 63 should be slid to adjust its position, and then it should be secured by tightening the screws at both ends thereof. First, as shown in FIG. 17A, a lens mounting section of the frame 63 is inserted into the casing. The lens mounting section, which is not shown here, has a structure as shown in FIGS. 14A to 14C. Then, as shown in FIG. 17B, the frame 63 is slid until protruding parts 632a and 632b engage with catches 633a and 633b, respectively, on the casing such that auxiliary securing sections 631a and 631b are formed. In this state, frame-side screw holes 634a and 634b and casing-side screw holes 635a and 635b are joined together by provisionally tightening screws 636a and 636b such that main securing sections 637a and 637b are formed as shown in FIG. 17C. Then, after adjusting the position of the frame 63 by sliding it so as not to distort the optical axis, the screws are tightened up to fix the relative position of the frame 63 to the casing.

Note here that the movable range of the frame 63 is within a horizontal play of the casing-side screw holes 635a and 635b shown in FIG. 17C, which is wide enough to cover the range necessary for the adjustment thereof. In this range, as shown in FIG. 17B, the protruding parts 632a and 632b are engaged with the catches 633a and 633b, respectively, on the casing, thereby forming the auxiliary securing sections 631a and 631b. In other words, when a maintenance work is to be carried out with the liquid crystal projector 1 suspended upside down from the ceiling, the frame 63 will not fall off the projector 1 even when the frame moves, provided that the screw is tightened provisionally in at least one of the main securing sections 637a and 637b. Also, if the auxiliary securing sections 631a and 631b are already formed, then the frame 63 will not fall off whether the screws are tightened in the main securing sections 637a and 637b or not.

Conventionally, to prevent the frame from falling off the projector 1 suspended from the ceiling, screw tightening had to be performed with one hand while the frame is supported with the other. However, provision of the protruding parts 632a and 632b on the frame 63, which are to engage with the catches 633a and 633b on the casing, has made it unnecessary to support the frame with one hand, thus freeing both hands to do the work. Thus, the replacement and adjustment works of a lens mounted on the frame 63 can be performed easily and safely with the liquid crystal projector 1 suspended from the ceiling. Also, this improves the efficiency of maintenance work without cost increase.

It should be noted that both the protruding parts 632a and 632b and the catches 633a and 633b may be provided on either of the light-entering side and the light-exit side in the auxiliary securing sections, but they may also be provided on both sides. Also, although there are two each of the protruding part and the catch in the present embodiment, there may be one or three or more of them each. Also, the auxiliary securing sections 631a and 631b are not limited to the configuration of the protruding parts on the frame and the catches on the casing; instead, the catches may be on the frame and the protruding parts on the casing. Otherwise, the protruding parts and the catches may be replaced by other alternative means.

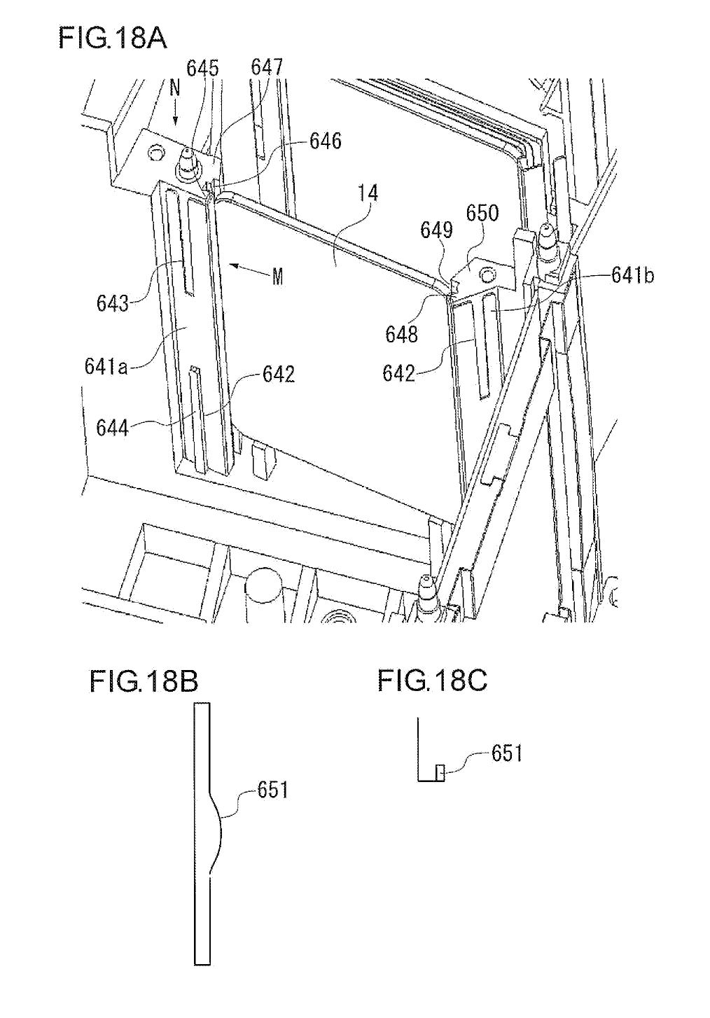

FIGS. 18A to 18C are each a perspective view showing a casing structure around an integrator lens. FIG. 18A is a perspective view showing an arrangement of pressure contact members 641a and 641b according to the present embodiment. FIG. 18B is an illustration of the pressure contact member 641a according to the present embodiment as viewed in the M direction of FIG. 18A. FIG. 18C is an illustration of the pressure contact member 641a according to the present embodiment as viewed in the N direction of FIG. 18A. The pressure contact members 641a and 641b, which have a pressing portion 651, are made of an elastic hard rubber, for instance.

The optical system 12 according to the present embodiment is housed in the optical system storage 46 formed of a heat-resistant resin with little thermal shrinkage and having an opening in the upper surface thereof, and the opening in the upper surface of the optical system storage 46 housing the optical system 12 is covered by the lid 47 shown in FIG. 16.

The liquid crystal projector 1 according to the present embodiment is provided with the first integrator lens 14 at a position in the light path closest to the light source unit 11. The first integrator lens 14 (shown in FIG. 18A), which is disposed between the left and right ribs, is inserted and held firmly in grooves 646 and 649 having a width slightly exceeding the thickness of the first integrator lens 14. A left-hand rib 645 is perpendicular to the light path, so that the groove 646 between ribs 645 and 647, which grips the integrator lens 14, is also perpendicular to the light path. On the other hand, of right-hand ribs 648 and 650, the rib 650 on the light-exiting side is perpendicular to the light path whereas the rib 648 on the light-entering side is tilting to the light-entering side.

As shown in FIGS. 18A and 18B, the pressure contact members 641a and 641b have each a pressing portion 651 which is a projection formed integrally therewith. The pressing portion 651, when the pressure contact members 641a and 641b are mounted respectively on the ribs 645 and 648, is positioned inside the grooves 646 and 649. The integrator lens 14 inserted in the grooves 646 and 649 is pressed against and fixed to the light-exiting-side ribs 647 and 650, respectively, by the elastic force of the pressing portion 651. The pressure contact member 641b, which is mounted on the right-hand rib 648, applies pressure to the first integrator lens 14 inserted in the groove 649 diagonally to the light-exiting side. That is, the pressure contact member 641b has not only a function of applying pressure to the first integrator lens 14 in the direction parallel to the light path the same way as the left-hand pressure contact member 641a, but also a function of applying pressure to it in the direction of the left-hand pressure contact member 641a. As a result, the first integrator lens 14 can be held perpendicular to the light axis, and at the same time the horizontal position of the first integrator lens 14 can be adjusted accurately. In other words, the light entering the first integrator lens 14 can exit precisely in the correct direction without deflecting. It is to be noted here that pressure contact members for the application of pressure to the first integrator lens 14, one each for the horizontal direction and the light path direction, may be used at the right-hand rib 648 or 650. Also, the left-hand and right-hand rib structures may be reversed.

The two pressure contact members 641a and 641b used in the present embodiment are identical in shape to each other. And they have slits 642 and 643, respectively, which are each in two longitudinal line-symmetric positions. Also, a projection 644 having the same shape as the slit is provided on each lower part of the left-hand and right-hand ribs so that it can engage with any of the slits. If the left-hand and right-hand pressure contact members 641a and 641b are so placed as to face each other and cover the light-incident-side ribs 645 and 648, respectively, then the positions of the pressure contact members 641a and 641b will be fixed firmly on their respective ribs 645 and 648. Thus, it is possible to secure the first integrator lens 14 reliably. Also, the identical shape of the pressure contact members 641a and 641b contributes to cost reduction.

As described above, use of the pressure contact members 641a and 641b realizes easy and reliable securing of the first integrator lens 14.

Although there has been a practice of using pressure contact members to secure lenses and the like in the past, it has solely been for the purpose of securing them in position. On the other hand, the pressure contact members 641a and 641b according to the present embodiment not only secure the first integrator lens 14, but also perform a function of protecting the resin sides of the ribs 645 and 648 against heat by absorbing and reflecting the light not transmitting through the optical component even when the light source is mounted on the tilt.

This makes it unnecessary to use additional parts for protecting the resin sides of the ribs 645 and 648 against heat, independently of securing the optical component. As a result, the number of components and the number of processes in fabrication can be reduced. Further, there is no need to use an expensive heat-resistant resin for the lid 47, which contributes to cost reduction.

It should be noted that the pressure contact members 641a and 641b may be metallic flat springs. In such a case, the resin sides of the ribs 645 and 648 can be covered amply with sheet metal. That is, the light from the light source can be absorbed or reflected by the sheet metal, so that the sides of the resin ribs 695 and 648 can be protected from heat. This will improve the durability of the casing. If metallic flat springs having also the pressure contact function are used, there will be no need to add new parts, apply a coat of paint on the sides of the ribs, or change the color of the resin. Such an arrangement will contribute to cost reduction.

In the present embodiment, the pressure contact members are used only for the purpose of securing the first integrator lens 14, which is the closest to the light source and thus presumably susceptible to the deterioration of resin from exposure to the light. However, the structure may be applied to other optical components such as the second integrator lens 16 and light-incident-side polarization plates that do not require fine adjustments.

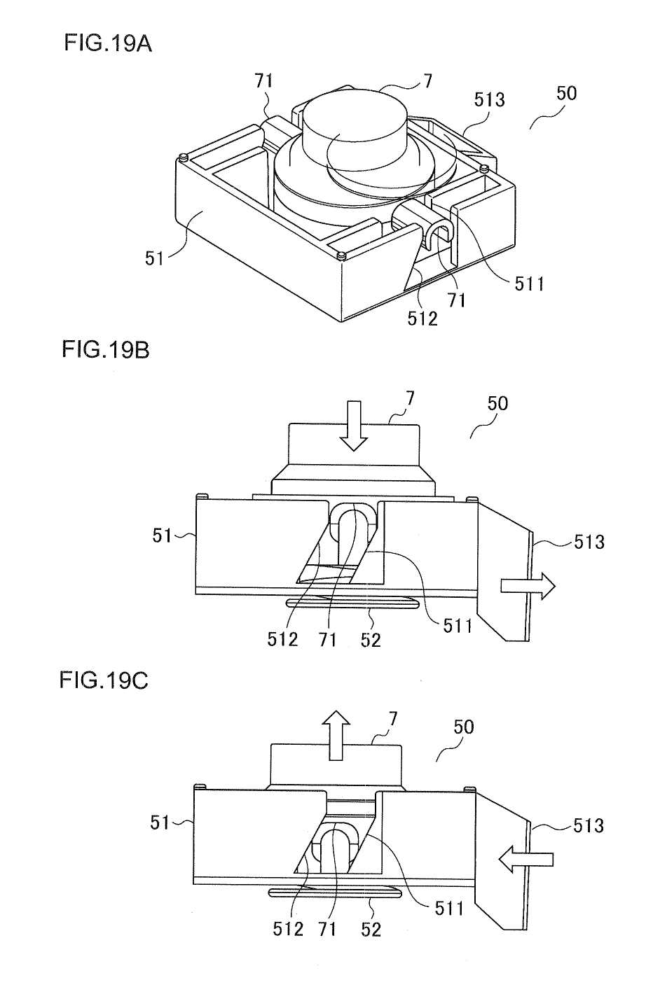

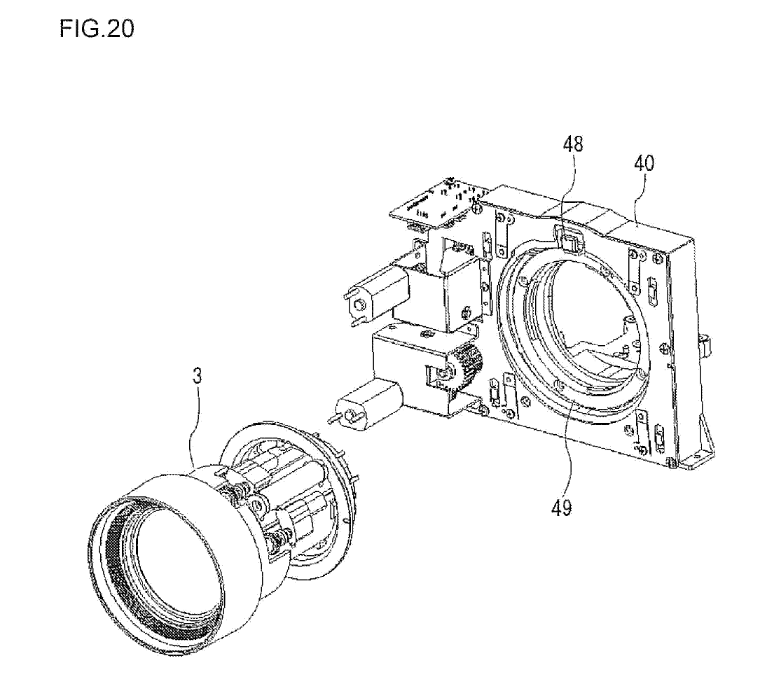

FIGS. 19A to 19C illustrate structures and operations of a projection lens removal unit. FIG. 20 is an exploded perspective view showing a projection lens mounting mechanism.

Similar to the conventional practice, a mounting mechanism, shown in FIG. 20, for the projection lens 3 is as follows. That is, similarly to interchangeable lenses for a camera, the projection lens 3 is secured by a pin which restricts the rotation of the projection lens 3 mounted in a screw-in manner. And a push button 48 for releasing the rotational restraint of the projection lens 3 restricted by this fixing pin is provided on top of a mount section 99 of the projection lens 3. A projection lens removal unit 50, as shown in FIGS. 19A to 19C, according to the present embodiment is mounted above the projection lens 3 such that it is located close to the push button 48 as shown in FIG. 2.

Referring to FIGS. 19A to 19C, the projection lens removal unit 50 according to the present embodiment includes a projection lens release button 7 whose top surface is exposed from the upper surface of the body casing 1 as shown in FIG. 1, a frame body 51 surrounding the projection lens release button 7, and an elastic body 52 comprised of a coiled spring that upwardly urges the projection lens release button 7. The projection lens release button 7 has an approximately cylindrical sliding member 71 that protrudes on both sides thereof. On the other hand, the frame body 51 is provided with a first inclined surface 511 on which one side of the sliding member 71 of the projection lens release button 7 slides, a second inclined surface 512 on which the other side of the sliding member 71 thereof slides, a pressing portion 513 that presses the push button 48 provided on the upper part of the mount section 49 of the projection lens 3, as shown in FIG. 20. For the sliding member 71, the frame body 51 and the first inclined surface 511 thereof constitute a driven mechanism, whereas the elastic body 52 and the second inclined surface 512 of the frame body 51 constitute a reciprocating mechanism.

In the above-described structure, as the projection lens release button 7 exposed on the upper surface of the body casing 1 is operated and moved downward as shown in FIG. 19B, the sliding member 71 provided on the projection lens release button 7 slides on the first inclined surface 511 provided on the frame body 51. This causes the frame body 51 to move in a direction perpendicular to the moving direction of the projection lens release button 7. Thus the push button 48 can be pressed by the pressing portion 513. As a consequence, the fixing pin of the projection lens 3 mounted on the projection mount section 49 is released, so that the projection lens 3 can be dismounted by rotating the projection lens 3.

After the projection lens 3 has been removed, the projection lens release button 7 is automatically returned to the initial position by the restoring force of the elastic body 52 placed on bottom of the projection lens release button 7, as shown in FIG. 19C. At the same time, the frame body 51, too, can be automatically reciprocated in response to the sliding motion of the sliding member 71 on the second inclined surface 512.

As a result, the projection lens release button 7 can be placed in the direction perpendicular to the moving direction of the push button 48 and therefore the restriction imposed on the mounting surface on which the projection lens release button 7 is to be mounted is reduced. Thus the projection lens release button 7 can be placed in such a manner as to be exposed on the upper surface of the body casing 1. As a result, a liquid crystal projector 1 featuring an increased operability of the projection lens release button 7 can be realized.

After the projection lens release button 7 has been operated, this projection release button 7 and the frame body 52 can be automatically returned to their original positions. This allows the driven movement to be effected using a minimum number of components in the direction perpendicular thereto and ensures the reciprocating movement of the projection lens mounting mechanism.

It should be noted here that if the push button 48 has sufficient restoring force, such ample restoring force can be maximally utilized and therefore the aforementioned reciprocating mechanism may be omitted.

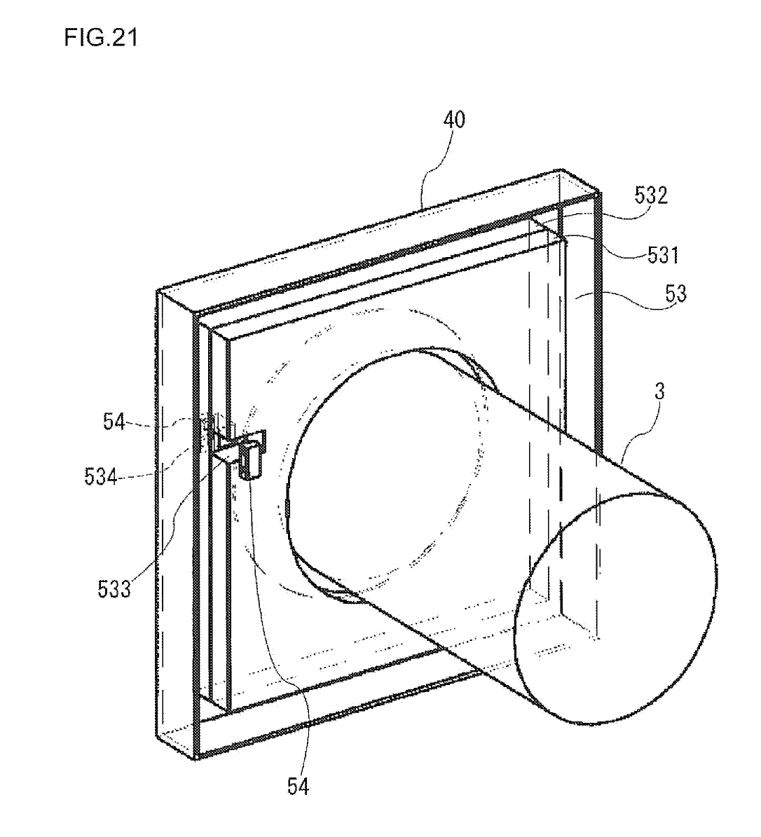

FIG. 21 illustrates a major structure of a projection lens moving unit according to an embodiment of the present invention;

This projection lens moving unit 53 is constituted by a vertically movable member 531 incorporated into a base 40, a horizontally movable member 532 incorporated thereinto, a drive mechanism (not shown in FIG. 21) for the vertically movable member 531 and the horizontally movable member 532, and a control mechanism to be discussed later. The projection lens moving unit 53 is structured as follows. That is, as the projection lens 3 is mounted on the horizontally movable member 532 and then the horizontally movable member 532 is driven, the projection lens 3 moves in the horizontal directions; as the vertically movable member 531 is driven, the horizontally movable member 532 moves vertically together with the vertically movable member 531 and thus the projection lens 3 moves in the vertical directions.

The vertically movable member 531 and the horizontally movable member 532 have through-holes 533 and 534, respectively, which are so formed as to communicate with each other and are of such a shape as to limit the movement. Separate type photo interrupters 54 and 54 are installed in openings on both sides of the vertically movable member 531 and the horizontally movable member 532. Since the horizontally movable member 532 moves independently in the horizontal directions, the vertically movable member 531 has the horizontally long through-hole 533.

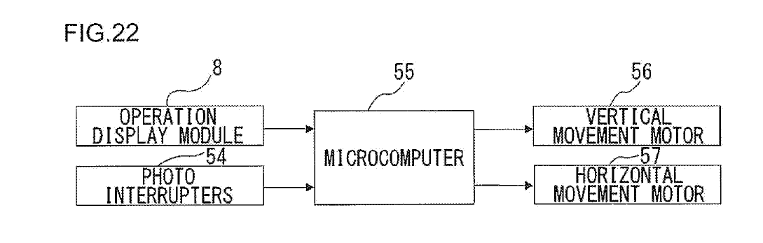

FIG. 22 is a block diagram showing a control mechanism of the above-described projection lens moving unit 53. A microcomputer 55 that constitutes a control means is so structured as to control a motor 56 for use in moving the lens vertically (hereinafter referred to as “vertical movement motor 56”) and a motor 57 for use in moving the lens horizontally (hereinafter referred to as “horizontal movement motor 57”) based on inputs from the operation display module 8 and the photo interrupters 54. The microcomputer 55 detects the position, of each of the movable members 531 and 532 moving in vertical and horizontal directions, at which the light is interrupted, based on outputs from the photo interrupters 54 and then determines the thus detected position to be the limit of movement. If the distance that the movable members 531 and 532 move is small, a normal U-shaped photo interrupters may be used instead of the separate type photo interrupters 54 and 54.

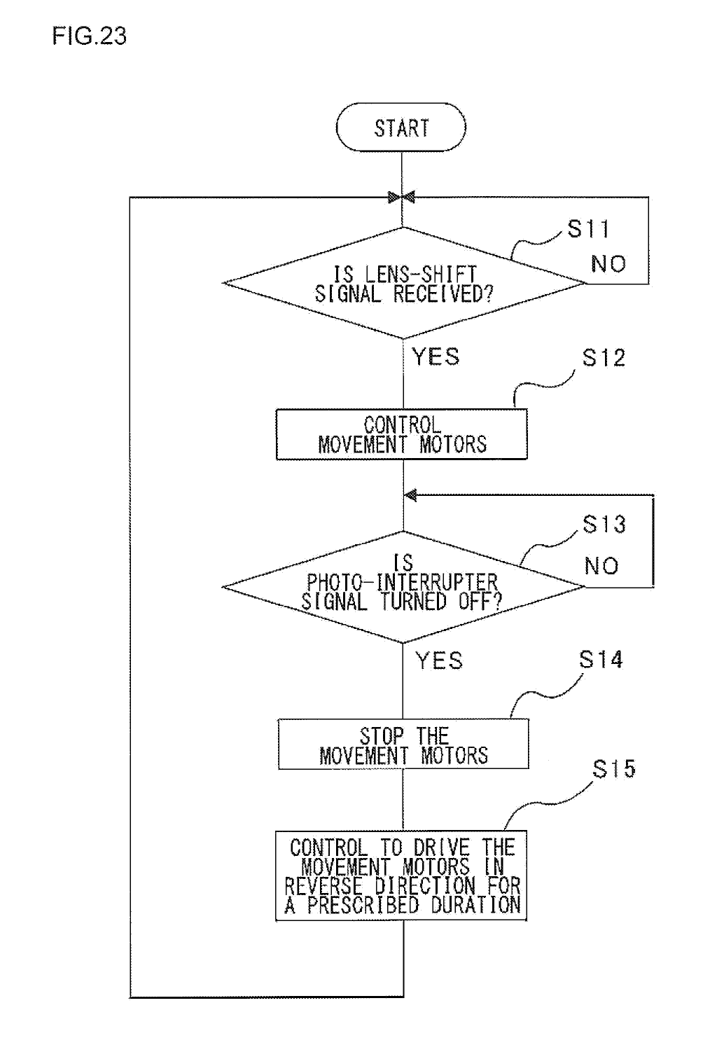

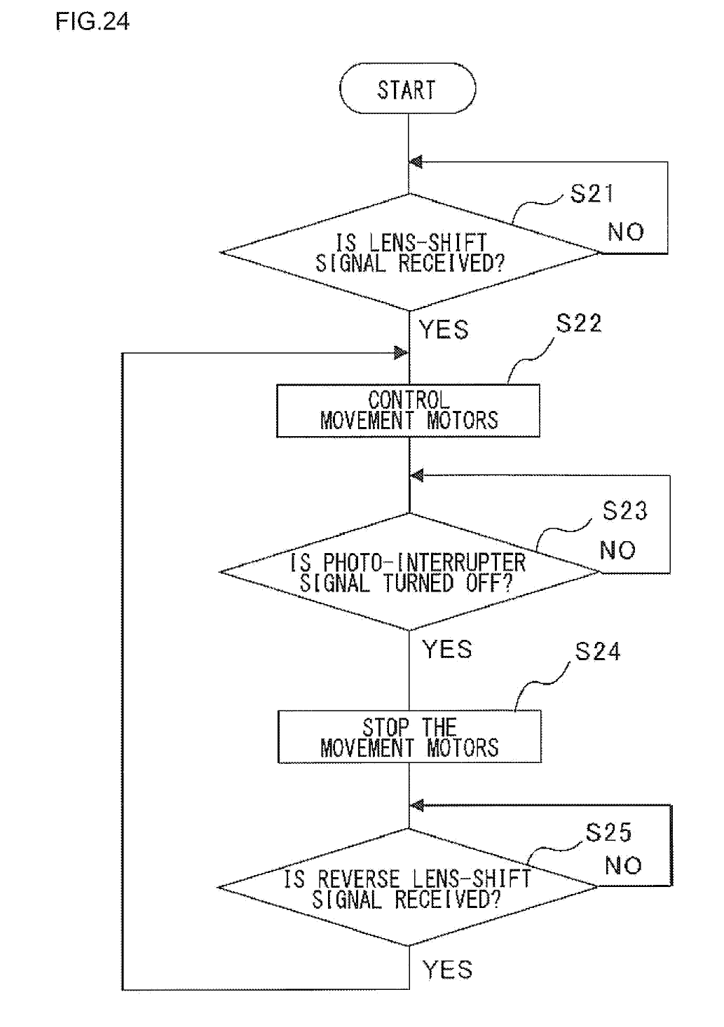

FIG. 23 and FIG. 24 are flowcharts showing exemplary procedures of controlling the limit of movement.

In an exemplary control performed in FIG. 23, the input of a lens shift signal from the operation display module 8 is awaited first (NO loop of Step S11); upon receipt of the input of the lens shift signal, the drive of either the vertical movement motor 56 or the horizontal movement motor 57 corresponding to the inputted lens shift signal is controlled in a corresponding direction (YES of Step S11 to Step S12).

Next, an OFF signal from the photo interrupters 54 is awaited (NO loop of Step S13). When the photo interrupter signal turns OFF, it is presumed that light is interrupted by the vertically movable member 531 or the horizontally movable member 532. Thus, it is determined that the movement limit has been reached, and the vertical movement motor 56 or the horizontal movement motor 57 being driven is stopped (YES of Step S13 to Step S14). Then, the vertical movement motor 56 or the horizontal movement motor 57 is controlled so that it runs in the reverse direction for a predetermined duration of time. This brings the lens back to within the range of the movement limit. Then the input of next lens shift signal is awaited (NO loop of Step S15 to Step S11).

Similarly to the above procedure in FIG. 23, in another exemplary control performed in FIG. 24 the input of a lens shift signal from the operation display module 8 is awaited first (NO loop of Step S21); upon receipt of the input of the lens shift signal, the drive of either the vertical movement motor 56 or the horizontal movement motor 57 corresponding to the inputted lens shift signal is controlled in a corresponding direction (YES of Step S21 to Step S22).

Next, an OFF signal from the photo interrupters 54 is awaited (NO loop of Step S23). When the photo interrupter signal turns OFF, it is presumed that light is interrupted by the vertically movable member 531 or the horizontally movable member 532. Thus, it is determined that the movement limit has been reached, and the vertical movement motor 56 or the horizontal movement motor 57 being driven is stopped (YES of Step S23 to Step S24). Then, the input of a reverse lens shift signal is awaited (NO loop of Step S25); upon receipt of the reverse lens shift signal, the procedure is returned to Step 22 so as to control the vertical movement motor 56 or the horizontal movement motor 57 (Step S25 to Step S22). In this exemplary control procedure as shown in FIG. 24, the control performed in Step 15 where the vertical movement motor 56 or the horizontal movement motor 57 runs in the reverse direction for a predetermined duration of time is not performed. Hence, once the movement limit is reached, only the reverse lens shift signal indicating the reverse direction of movement is received in Step S25.

As described above, a pair of photo interrupters 54 and 54 makes it possible to determine the limit of movement in the vertical and horizontal directions, thus achieving a cost reduction. Also, the limit of movement is achieved by the use of members used to move the projection lens 3 without involving any other components, so that the limit of movement can be set and controlled accurately. Further, the limit of movement may be set and controlled using an arbitrary shape, other than a quadrilateral, of the through-holes 533 and 534 formed in the vertically movable member 531 and the horizontally movable member 532 of the projection lens moving unit 53.

In the above-described embodiments, a description has been given of the liquid crystal projector, which uses LCD panels as light modulation devices, as a projection type image display apparatus. However, the present embodiments are also applicable to a projection type image display apparatus provided with other image light generation systems except when the LCD panels are indispensable. For example, the present embodiments are also applicable to a DLP (Digital Light Processing) projector (DPL is a registered trademark of Texas Instruments (TI) Inc).

While the preferred embodiments of the present invention have been described using specific terms, such description is for illustrative purposes only, and it is to be understood that changes and variations may further be made without departing from the spirit or scope of the appended claims.

What is claimed is:

1. An optical apparatus including a frame, having an optical component, mounted on a casing,
wherein the casing is provided with a groove in which the frame is inserted and a mount section to which a first part of an auxiliary member used to fix the casing and the frame is fixed,
wherein the frame is provided with a frame-side positioning section which is engaged with a second part of the auxiliary member when the frame is inserted in the groove and set at a predetermined angle of rotation,
wherein the auxiliary member is provided with the first part which is fixed to the mount section of the casing and the second part which is engaged with a frame-side positioning section, and
wherein the first part and the second part of the auxiliary member are formed in positions separate from each other while the second part is engaged with the frame-side positioning section under an elastic force of the auxiliary member.

2. An optical apparatus according to claim 1, wherein the force from the second part of the auxiliary member works on the frame in a direction perpendicular to an optical axis of the optical component when the second part is engaged with the frame-side positioning section.

3. An optical apparatus according to claim 1, wherein the optical component is either a polarization plate or an optical compensation plate.

4. An optical apparatus according to claim 2, wherein the optical component is either a polarization plate or an optical compensation plate.

5. An optical apparatus according to claim 1, further including an engagement portion having an elastic force, configured to engage with the groove, which is formed in a middle part of each lateral edge of the frame.

6. An optical apparatus according to claim 1, wherein the auxiliary member is mounted on the casing using a single mounting member.

7. An optical apparatus according to claim 1, wherein the frame has at least two rounded lower corners.

8. An optical apparatus according to claim 1, wherein the frame-side positioning section is a round projection.

9. An optical apparatus according to claim 1, wherein the frame has a handgrip for use in rotation adjustment.

10. A projection type image display apparatus including an optical apparatus according to claim 1, wherein light emitted from a light source is modulated and outputted based on image signals.

11. A projection type image display apparatus including an optical apparatus according to claim 2, wherein light emitted from a light source is modulated and outputted based on image signals.
